(19) United States
(12) Patent Application Publication
(10) Pub. No.: US 2012/0054634 A1
(43) Pub. Date: Mar. 1, 2012

(54) APPARATUS FOR AND METHOD OF CREATING A CUSTOMIZED UI BASED ON USER PREFERENCE DATA

(75) Inventors: Glen David Stone, Los Gatos, CA (US); James Amendolagine, San Marcos, CA (US); Jason Clement, San Diego, CA (US)

(73) Assignee: SONY CORPORATION, Tokyo (JP)

(21) Appl. No.: 12/870,715

(22) Filed: Aug. 27, 2010

(51) Int. Cl. G06F 3/048; G06F 15/16

(52) U.S. Cl. 715/745

(57) ABSTRACT

A customized RUI based on user preferences is able to make the RUI experience for the user more enjoyable, as well as provide a safe viewing environment for families. The customized RUI is implemented when a user is detected. The customized RUI is presented on a rendering device so that each user experiences a customized version of entertainment.

### FIELD OF THE INVENTION

The present invention relates to the field of remote user interfaces. More specifically, the present invention relates to generating a customized a remote user interface based on user preference data.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Home networks employ quality of service to manage bandwidth resource and UPnP or UPnPForum to perform discovery and compatibility of compressed video content. UPnP for video also defines network user input operation like play, stop and rewind so that video control as well as video display is able to be performed remotely. Also, provisions were made to support the discovery of a remote user interface. UPnP does not specify the standards to compress the video content. Digital Living Network Alliance (DLNA) is a consortium formed to provide certified device compatibility for a specific subset of UPnP implementations, including the standards for video compression. It also defined the role of media servers, renderers, adapters, players and controllers.

A standard, referred to as Remote User Interface (RUI or Remote UI) allows devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

UPnP does not define graphical RUI, but supports the discovery of graphical RUI implementations. One option, which has been backed by the UPnP Forum, for a browser based implementation for graphical RUI is CEA2014. The network client browser is considered to be heavy in Flash memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, browser support adds to the already substantial memory requirements of the renderers and so for these cost sensitive consumer electronics devices it may not be viable. Secondly, the processing speed requirements for a responsive user experience are not available across all devices. And thirdly, the browser interface lends itself well to mouse and keyboard control, but is not necessarily the ideal format for a limited button remote control.

Also, the home network is able to support graphics applications built into game machines, video players, dongles and intelligent remotes on the low end, with cable boxes, cloud servers and multimedia PCs on the high end. To force all of these into one standard, it is clear that the reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. This type of RUI would be considered a thin network client and thick network server because most of the computation effort would be with the application. Also, because most actions involve sending image data, this type of RUI uses a lot of network resources.

The advantage of RVU is that it is able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

### SUMMARY OF THE INVENTION

A customized RUI based on user preferences is able to make the RUI experience for the user more enjoyable, as well as provide a safe viewing environment for families. The customized RUI is implemented when a user is detected. The customized RUI is presented on a rendering device so that each user experiences a customized version of entertainment.

In one aspect, a method of generating a customized remote user interface comprises detecting a user's presence, communicating the presence to a server device, generating a customized remote user interface based on user preferences, sending the customized remote user interface to a rendering device and rendering the customized remote user interface. The method further comprises inputting user selection commands using an input device and the customized remote user interface. The input device is selected from the group consisting of a speech recognition device, motion recognition device and a biometric device. The method further comprises discovering devices in a network. Detecting is selected from the group consisting of face detection, voice detection, biometric recognition, user registration and device detection and identification. The customized remote user interface is generated by a preference engine. User behaviors are learned by the preference engine and stored in a database. The customized remote user interface includes a remote user interface with features added or deleted. The user preferences are stored in a database. The database includes groups of users with preferences separated by the groups. The database is stored on a storing device selected from the group consisting of a hard disk drive, a solid-state drive and a memory card. The server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.

In another aspect, a network of devices comprises a detection device for detecting a user's presence, a server device coupled to the detection device for generating a customized remote user interface based on the user's presence and a rendering device coupled to the server device for rendering the customized remote user interface. The network of devices further comprises a source device for communicating a remote user interface display page. The source device communicates the remote user interface display page to the rendering device through the server device. The network of devices further comprises an input device for inputting user selection commands for controlling the customized remote user interface. The input device is selected from the group consisting of a speech recognition device, motion recognition device and a biometric device. The detection device, the server device and the rendering device are discoverable. Detecting the user's presence is selected from the group consisting of face detection, voice detection, biometric recognition, user registration and device detection and identification. The customized remote user interface is generated by a preference engine. The user preferences are learned by the preference engine and stored in a database. The customized remote user interface includes a remote user interface with features added or deleted. The user preferences are stored in a database. In some embodiments, the database includes groups of users with preferences separated by the groups. The database is stored on a storing device selected from the group consisting of a hard disk drive, a solid-state drive and a memory card. The detection device, the server device and the rendering device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.

In another aspect, a system programmed in a controller in a device comprises a discovery module for discovering devices on a network, a detection module for detecting a user's presence, a user preference engine for learning the user's preferences, communicating with a database and generating a customized remote user interface utilizing the user's preferences and a communication module for communicating the customized remote user interface to a rendering device. Detecting the user's presence is selected from the group consisting of face detection, voice detection, biometric recognition, user registration and device detection and identification. The customized remote user interface includes a remote user interface with features added or deleted. The user preferences are stored in a database. The database includes groups of users with preferences separated by the groups. The database is stored on a storing device selected from the group consisting of a hard disk drive, a solid-state drive and a memory card. The controller is selected from the group consisting of a programmed computer readable medium and an application-specific circuit.

In yet another aspect, a server device comprises a memory for storing an application, the application for generating a customized remote user interface based on user preferences, sending the customized remote user interface to a rendering device and a processing component coupled to the memory, the processing component for processing the application. Generating the customized remote user interface is by a user preferences engine which utilizes the user preferences. The customized remote user interface includes a remote user interface with features added or deleted. The user preferences are stored in a database. The database includes groups of users with preferences separated by the groups. The database is stored on a storing device selected from the group consisting of a hard disk drive, a solid-state drive and a memory card.

### BRIEF DESCRIPTION OF THE DRAWINGS

FIG. 1 illustrates a block diagram of a network of devices implementing a method of customizing an RUI using a server device according to some embodiments.

FIG. 2 illustrates a flowchart of a method of utilizing a server device to customize an RUI according to some embodiments.

FIG. 3 illustrates a block diagram of an exemplary computing device to customize an RUI according to some embodiments.

FIG. 4 illustrates an exemplary database organization utilized by the server device according to some embodiments.

### DETAILED DESCRIPTION OF THE PREFERRED EMBODIMENT

A system to generate a customized Remote User Interface (RUI) based on user presence data (virtual or actual) including presence detection (face, audio, roll call HFC and/or others) is described herein. The presence information is communicated to a remote device which generates the RUI based on the presence data, a personal profile, a device profile and/or service information.

In a home with multiple users of devices on the home network, using presence detection coupled with a user preference engine and database, an RUI is able to be customized to the user that is interacting with the RUI. In the case of multiple users interacting with the RUI client, the presence detection engine provides the multiple users to the server.

A customized RUI based on user preferences and behaviors is able to make the RUI experience for the user more enjoyable, as well as provide a safe viewing environment for families. For example, the RUI preferences are able to be set to remove content that exceeds a certain content rating when children are in the room. When the children leave the room, the presence engine detects that only adults are in the room and adjusts the RUI content accordingly.

A user preferences database is discoverable in the network, and users are able to set preferences and/or a preference engine is able to learn a user's preferences and behaviors and populate the database. A source device is also discoverable.

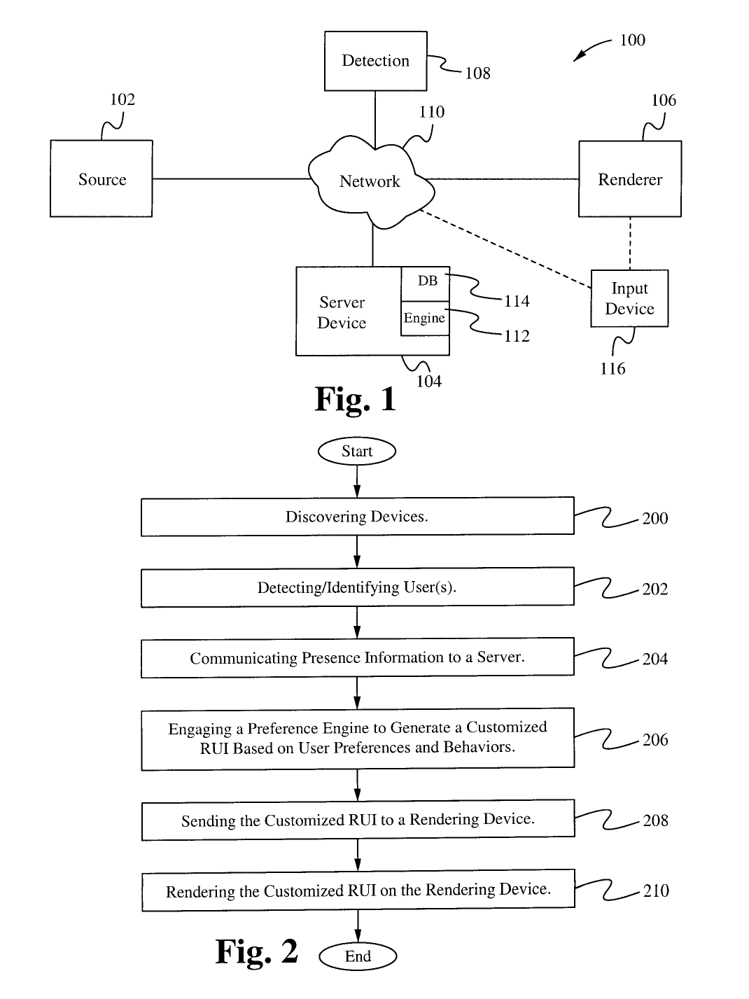

FIG. 1 illustrates a block diagram of a network of devices implementing a method of customizing an RUI using a server device according to some embodiments. The network of devices 100 includes one or more gateway or source devices 102 coupled to a server device 104, a rendering device (e.g. a television) 106 and a detection device 108. In some embodiments, the source device 102, the server device 104, the rendering device 106 and the detection device 108 are coupled directly, and in some embodiments, at least a portion of them are coupled through a network 110. The network 110 is able to be any type of network including, but not limited to, a LAN, a WAN, the Internet, a cellular network, a wireless network, a wired network and/or any combination thereof. In some embodiments, the network 110 is networks bridged together.

In some embodiments, the network of devices 100 includes an input device 116 (such as a remote control device). In some embodiments, the input device 116 communicates through the rendering device 106. In some embodiments, the input device 116 communicates through the network 110 as a network device. In the case that the input device 116 interfaces with the network 110, the input device also includes a renderer to render the RUI. The input device 116 sends user selection commands available from the RUI graphical display. The input device 116 is used to set preferences and/or correct learned behaviors. In some embodiments, the input device 116 is able to implement speech recognition, motion recognition and/or any other input implementation.

The source device 102 is any device that sends RUI data such as RUI display pages to a rendering device 106. In some embodiments, the source device 102 sends the RUI data to the rendering device 106 directly. In some embodiments, the source device 102 sends the RUI data to the rendering device 106 through the server device 104. In some embodiments, the source device 102 also sends information such as device information and/or user information to the server device 104. In some embodiments, the RUI data from the source device 102 is sent to the server device 104 which processes the RUI data and then sends a customized RUI to the rendering device 106. In some embodiments, the source device 102 also receives the customized RUI from the server device 104. In some embodiments, the source device 102 is able to discover devices such as the server device 104 and the rendering device 106. In some embodiments, the source device 102 is able to generate a customized RUI using information received from the server device 104.

The server device 104 is any device that is able to store information regarding devices, users of the devices and user preferences/behaviors and any other information related to the users and/or devices. In some embodiments, the server device 104 receives user detection information and utilizes that information to generate a customized RUI. In some embodiments, the server device 104 is able to identify users, identify source and rendering devices and generate a customized RUI. In some embodiments, in addition to the detection/user information, the server generates the customized RUI based on the information in a database 114 regarding the users and the source and rendering devices. In some embodiments, the server device 104 includes a user preferences engine 112 which is able to learn user's preferences and behaviors and populate the database 114. Based on the user, the devices and the associated user preferences, the server device 104 is able to tailor the RUI specifically for that user or a set of users (e.g. kids or adults). After the customized RUI is generated, the customized RUI is sent to the rendering device 106 and/or the source device 102. The server device 104 allows and enables additions/updates to user settings and corrections to the customized RUI. In some embodiments, the customized RUI or at least a copy of the customized RUI is stored in the server device 104. In some embodiments, the server device 104 is able to generate an RUI for custom input for the user input device 116. For example, control key layouts are able to be generated to match the specific layout of the manufacturer's remote control.

The database 114 stored within the server device 104 stores and links data such as user information with device information. As one example, stored in the database is a relationship between a device with a specific MAC address and the user or users of that device. Furthermore, the preferences of that user are stored in the database such as favorite channels.

The user preferences engine 112 is able to utilize user detection information, device information and/or any other information to determine user preferences and behaviors to populate the database 114. The engine 112 determines or learns user preferences and behaviors in any manner. For example, the engine 112 monitors channels and/or shows commonly watched by a user and determines that those channels are “favorite” channels, or determines similar shows such as other comedies as the types of shows a user prefers. The engine 112 is able to include other information as well such as sports are best watched with certain settings, and if sports are recognized as being watched, those settings are able to be set automatically. In some embodiments, the preferences engine 112 generates the customized RUI or provides the appropriate content based on user preferences. In some embodiments, the user preferences engine 112 is stored on a separate device than the server device 104.

The rendering device 106 is any device that is able to render and display the customized RUI, for example, a television.

The detection device 108 is any device that is able to detect a user (or a user's presence). Examples of detecting a user include: using a camera to detect a face, mobile devices such as cellular phones are able to indicate a user's presence, registration by the user using the source device (e.g. login), NFC id cards and any other detection mechanism. In some embodiments, the user is detected by identifying a device. Devices are identified by any implementation, such as by MAC ID, device ID, Transferjet information, RFID and FeliCa information, face/voice/biometric recognition data and other identifiers, coupling to a remote database of device specifications and user profiles and generating a customized RUI based on results of information output from the database. In some embodiments, the detection device 108 is the same as or is incorporated with the source device 102 and/or the server device 104.

For example, in operation, a camera identifies a user (e.g. using face recognition) and communicates the presence information to the server. The server engages the preference engine which utilizes stored information about that user in the database to provide the appropriate RUI according to the user preferences. The customized RUI is then sent to a television where it is displayed, and the user is able to more efficiently utilize the RUI that is specifically designed for the user(s).

In some embodiments, more or fewer devices than those shown in FIG. 1 are implemented. For example, in one implementation, there is no separate detection device since it is incorporated within the source device. In another example, there is no source device. In yet another example, multiple rendering devices exist.

FIG. 2 illustrates a flowchart of a method of utilizing a server device to customize an RUI according to some embodiments. In the step 200, devices are discovered. The devices are discovered using any method such as UPnP. Mobile devices are able to be discovered as well. In some embodiments, a server device discovers source and rendering devices. In some embodiments, the source devices and the rendering devices discover the server device. Any device is able to discover another device. In the step 202, a user or users are detected and identified. In some embodiments, a dedicated detection device is utilized, and in some embodiments, any device is utilized for user detection (e.g. a source device or a server device). The method of detection is any method such face detection, biometrics, login, id cards and/or any other method. In the step 204, the presence information is communicated to the server. In the step 206, the server engages the preference engine which generates a customized RUI and provides the appropriate content according to user preferences and behaviors. In the step 208, the customized RUI is sent to one or more rendering devices. In the step 210, the customized RUI is rendered on the rendering device(s). In some embodiments, the customized RUI is also sent to the source device(s) which then could send the customized RUI to the rendering device(s). In some embodiments, an input device is used to send user selection commands available from the customized RUI on the rendering device, and in some embodiments, the input device is used to render a customized RUI. Although specific steps are described, in some embodiments, fewer or more steps are included, and/or the order of the steps is able to be changed.

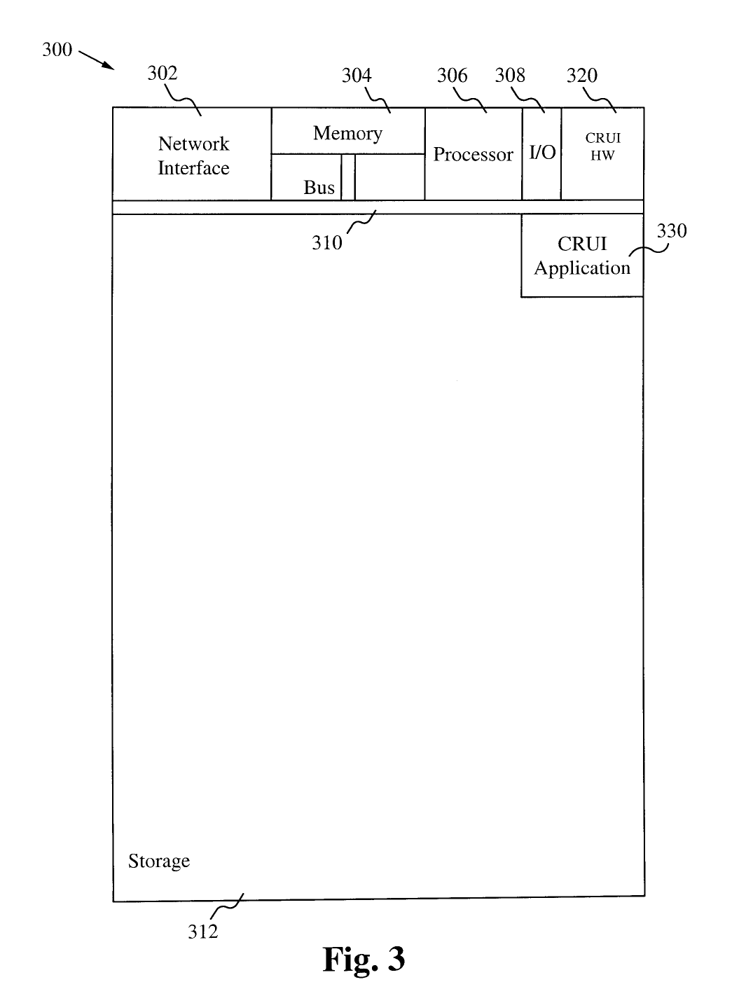

FIG. 3 illustrates a block diagram of an exemplary computing device 300 to customize an RUI according to some embodiments. The computing device 300 is able to be used to acquire, store, compute, communicate and/or display information. For example, the computing device 300 is able to receive, generate, modify, store, and customize an RUI. In some embodiments, the computing device 300 also has a user preference engine and a database with information. The engine is used to provide content according to user preferences. The information stored within the database is used to generate the customized RUI. The customized RUI is then able to be stored on the computing device 300. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, a solid-state drive, CDROM, CDRW, DVD, DVDRW, Blu-ray®, Flash memory card, stick or drive, or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. The I/O device(s) 308 are used to set preferences and/or correct learned behaviors. Customizing RUI application(s) 330 used to perform the customizing RUI method are likely to be stored in the storage device 312 and memory 304 and processed as applications are typically processed. More or less components shown in FIG. 3 are able to be included in the computing device 300. In some embodiments, customizing RUI hardware 320 is included. Although the computing device 300 in FIG. 3 includes applications 330 and hardware 320, the customizing RUI method is able to be implemented on a computing device in hardware, firmware, software or any combination thereof. For example, in some embodiments, the customizing RUI applications 330 are programmed in a memory and executed using a processor. In another example, in some embodiments, the customizing hardware 320 is programmed hardware logic including gates specifically designed to implement the customizing RUI method.

In some embodiments, the customizing RUI application(s) 330 include several applications and/or modules. As described herein, the modules are able to include a discovery module for discovering devices, a detection module for detecting a device and/or a user (specifically, a user's presence), a user preference engine for learning preferences, communicating with a database and generating a customized RUI and a communication module for communicating data to and from the computing device. In some embodiments, modules include one or more sub-modules as well. In some embodiments, fewer or additional modules are able to be included.

Examples of suitable computing devices for the server device, source device and rendering device include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, ebook reader, near field devices such as cards that use TransferJet, RFID and FeliCa, monitoring devices such as a heart monitor, robots such as Roomba, a television, a home entertainment system or any other suitable computing device. In some embodiments, a computing device is able to include intelligent appliances such as a refrigerator, a toaster, a toaster oven and a microwave, where the appliances are able to process and/or present information.

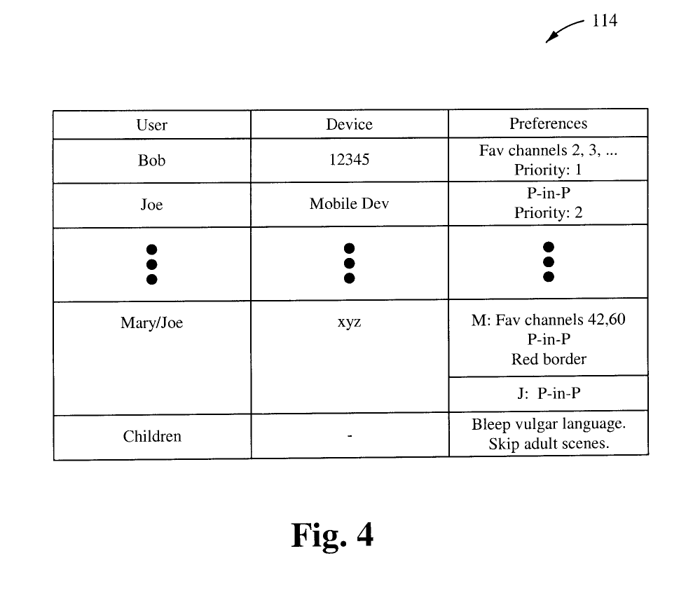

FIG. 4 illustrates an exemplary database organization utilized by the server device according to some embodiments. The database 114 includes information related to devices, users and the preferences/behaviors of the users so that an RUI is able to be customized for that user or group of users. In the exemplary database 114, a first column includes user information. In some embodiments, the user information corresponds to or is associated with the device identification information. For example, each device is assigned to one or more users, or one or more users are assigned to a device. The assignment of the devices is able to be through a user interface or any other means. For example, a consumer device stores a user's name and sends the name to the server device when communicating with the server device. For some devices, multiple users use the same device. For the devices with multiple users, an implementation enables a user of the device to be determined. For example, the user is able to press a button, select their name or log in to indicate they are the user of the device. A second column includes device identification information. For example, devices are able to be identified by a serial number, a MAC address, a name, a device type, Transferjet information, RFID and FeliCa information, face/voice/biometric recognition data and/or any other device identifier. A third column includes preference information so that the customized RUI is configured for that user. Exemplary preference information includes favorite channels, picture-in-picture options, screen size, borders, television settings, widget placement, volume settings and any other data. In some embodiments, preferences are able to be included, such as controlling other devices in response to a selection. For example, lights are dimmed and/or a phone is muted if a movie is selected. In some embodiments, the preference information is generated from the user preferences engine through learning user preferences/behaviors. Although three columns are shown with Device, User and Preferences as labels, the database is able to have any number of columns and use any labeling. For example, additional information is able to be stored in the database such as specifications of the rendering device. In some embodiments, priorities are also included in the database 114. For example, the priorities are able to designate which customization is implemented if there is a conflict. For example, if one user has a setting of wide screen for watching movies while a second user has a setting of full screen for movies, these two settings are unable to coexist if both users are watching at the same time on the same device. Using the priorities, the higher priority setting is selected. Although a database is described, any data structure and configuration of the data structure is possible such as a linked list, a two dimensional array or any other data structure.

In some embodiments, the database 114 is stored on a hard disk in a home network. In some embodiments, the database 114 is stored on a portable device (for example, copied from the hard disk) so that a user is able to take the database 114 to different locations (e.g. a friend's house). The portable device is any device capable of storing the database 114 such as a mobile phone or watch containing a storage component or a memory card.

To utilize the method of customizing an RUI, user(s) are detected. For example, a camera is able to detect the people in a family room. In some implementations, the users have to do nothing more than walk into a room to be detected, and in some implementations, the users manually log in. The user information is communicated to a server device which includes a user preference engine which is used to generate a customized RUI specific to the detected users. In some implementations, the user inputs preferences such as parental controls, and in some implementations, the preferences/behaviors are learned by the preference engine. In some embodiments, the preferences are entered once (e.g. upon initialization) or periodically. In some embodiments, the learning of the preferences occurs by monitoring user actions. For example, if a user typically watches channels 2,3 and 38, the engine records them as “favorites.” Similarly, other settings, patterns and information are able to be learned. The customized RUI is then communicated to a rendering device such as a television which renders the customized RUI. The user is then able to enjoy, for example, watching a movie, with the settings that are specifically configured for that user or users. In one example, a person enjoys movies at a certain volume level, with subtitles on and the color contrast darker, yet another person enjoys movies at a different volume, wide screen and no subtitles. In a different example, a parent is able to set parental control so that whenever a child is detected in the room, any inappropriate content is removed in some manner. These settings are able to be contained in the database used to generate the customized RUI.

In operation, a customized RUI based on user preferences is able to make the RUI experience for the user more enjoyable, as well as provide a safe viewing environment for families. User(s) are recognized, and then the user presence is utilized by a server to generate a customized RUI which is displayed on a rendering device. By recognizing the user(s), generating the customized RUI and displaying the customized RUI, a user has a better experience with the rendering device. The customized RUI is able to make navigating on the rendering device easier, provide varying appearances to the rendering device and any other modification to the rendering device.

In some embodiments, the RUI is able to include physical entities such as blinking lights or moving parts. For example, a Roomba™ shakes when it needs attention.

In some embodiments, the devices implemented within the network described herein are able to implement Digital Living Network Alliance (DLNA) standard as well.

### Some Embodiments of an Apparatus for and Method of Creating a Customized UI Based on User Preference Data

1. A method of generating a customized remote user interface comprising:
   a. detecting a user's presence;
   b. communicating the presence to a server device;
   c. generating a customized remote user interface based on user preferences;
   d. sending the customized remote user interface to a rendering device; and
   e. rendering the customized remote user interface.
2. The method of clause 1 further comprising inputting user selection commands using an input device and the customized remote user interface.
3. The method of clause 2 wherein the input device is selected from the group consisting of a speech recognition device, motion recognition device and a biometric device.
4. The method of clause 1 further comprising discovering devices in a network.
5. The method of clause 1 wherein detecting is selected from the group consisting of face detection, voice detection, biometric recognition, user registration and device detection and identification.
6. The method of clause 1 wherein the customized remote user interface is generated by a preference engine.
7. The method of clause 6 wherein user behaviors are learned by the preference engine and stored in a database.
8. The method of clause 1 wherein the customized remote user interface includes a remote user interface with features added or deleted.
9. The method of clause 1 wherein the user preferences are stored in a database.
10. The method of clause 10 wherein the database includes groups of users with preferences separated by the groups.
11. The method of clause 10 wherein the database is stored on a storing device selected from the group consisting of a hard disk drive, a solid-state drive and a memory card.
12. The method of clause 1 wherein the server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.
13. A network of devices comprising:
   a. a detection device for detecting a user's presence;
   b. a server device coupled to the detection device for generating a customized remote user interface based on user preferences; and
   c. a rendering device coupled to the server device for rendering the customized remote user interface.
14. The network of devices of clause 13 further comprising a source device for communicating a remote user interface display page.
15. The network of devices of clause 14 wherein the source device communicates the remote user interface display page to the rendering device through the server device.
16. The network of devices of clause 13 further comprising an input device for inputting user selection commands for controlling the customized remote user interface.
17. The network of devices of clause 16 wherein the input device is selected from the group consisting of a speech recognition device, motion recognition device and a biometric device.
18. The network of devices of clause 13 wherein the detection device, the server device and the rendering device are discoverable.
19. The network of devices of clause 13 wherein detecting the user's presence is selected from the group consisting of face detection, voice detection, biometric recognition, user registration and device detection and identification.
20. The network of devices of clause 13 wherein the customized remote user interface is generated by a preference engine.
21. The network of devices of clause 20 wherein user behaviors are learned by the preference engine and stored in a database.
22. The network of devices of clause 13 wherein the customized remote user interface includes a remote user interface with features added or deleted.
23. The network of devices of clause 13 wherein the user preferences are stored in a database.
24. The network of devices of clause 23 wherein the database includes groups of users with preferences separated by the groups.
25. The network of devices of clause 23 wherein the database is stored on a storing device selected from the group consisting of a hard disk drive, a solid-state drive and a memory card.
26. The network of devices of clause 13 wherein the detection device, the server device and the rendering device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.
27. A system programmed in a controller in a device comprising:
   a. a discovery module for discovering devices on a network;
   b. a detection module for detecting a user's presence;
   c. a user preference engine for learning the user's preferences, communicating with a database and generating a customized remote user interface utilizing the user's preferences; and
   d. a communication module for communicating the customized remote user interface to a rendering device.
28. The system of clause 27 wherein detecting the user's presence is selected from the group consisting of face detection, voice detection, biometric recognition, user registration and device detection and identification.
29. The system of clause 27 wherein the customized remote user interface includes a remote user interface with features added or deleted.
30. The system of clause 27 wherein the user preferences are stored in a database.
31. The system of clause 30 wherein the database includes groups of users with preferences separated by the groups.
32. The system of clause 30 wherein the database is stored on a storing device selected from the group consisting of a hard disk drive, a solid-state drive and a memory card.
33. The system of clause 27 wherein the controller is selected from the group consisting of a programmed computer readable medium and an application-specific circuit.
34. A server device comprising:
   a. a memory for storing an application, the application for:
      i. generating a customized remote user interface based on user preferences; and
      ii. sending the customized remote user interface to a rendering device;
      iii. allowing user settings and corrections to the customized remote user interface; and
   b. a processing component coupled to the memory, the processing component for processing the application.
35. The server device of clause 34 wherein generating the customized remote user interface is by a user preferences engine which utilizes the user preferences.
36. The server device of clause 34 wherein the customized remote user interface includes a remote user interface with features added or deleted.
37. The server device of clause 34 wherein the user preferences are stored in a database.
38. The server device of clause 37 wherein the database includes groups of users with preferences separated by the groups.
39. The server device of clause 37 wherein the database is stored on a storing device selected from the group consisting of a hard disk drive, a solid-state drive and a memory card.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of generating a customized remote user interface comprising:
a. detecting a user's presence;
b. communicating the presence to a server device;
c. generating a customized remote user interface based on user preferences;
d. sending the customized remote user interface to a rendering device; and
e. rendering the customized remote user interface.

2. The method of claim 1 further comprising inputting user selection commands using an input device and the customized remote user interface.

3. The method of claim 2 wherein the input device is selected from the group consisting of a speech recognition device, motion recognition device and a biometric device.

4. The method of claim 1 further comprising discovering devices in a network.

5. The method of claim 1 wherein detecting is selected from the group consisting of face detection, voice detection, biometric recognition, user registration and device detection and identification.

6. The method of claim 1 wherein the customized remote user interface is generated by a preference engine.

7. The method of claim 6 wherein user behaviors are learned by the preference engine and stored in a database.

8. The method of claim 1 wherein the customized remote user interface includes a remote user interface with features added or deleted.

9. The method of claim 1 wherein the user preferences are stored in a database.

10. The method of claim 10 wherein the database includes groups of users with preferences separated by the groups.

11. The method of claim 10 wherein the database is stored on a storing device selected from the group consisting of a hard disk drive, a solid-state drive and a memory card.

12. The method of claim 1 wherein the server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.

13. A network of devices comprising:
a. a detection device for detecting a user's presence;
b. a server device coupled to the detection device for generating a customized remote user interface based on user preferences; and
c. a rendering device coupled to the server device for rendering the customized remote user interface.

14. The network of devices of claim 13 further comprising a source device for communicating a remote user interface display page.

15. The network of devices of claim 14 wherein the source device communicates the remote user interface display page to the rendering device through the server device.

16. The network of devices of claim 13 further comprising an input device for inputting user selection commands for controlling the customized remote user interface.

17. The network of devices of claim 16 wherein the input device is selected from the group consisting of a speech recognition device, motion recognition device and a biometric device.

18. The network of devices of claim 13 wherein the detection device, the server device and the rendering device are discoverable.

19. The network of devices of claim 13 wherein detecting the user's presence is selected from the group consisting of face detection, voice detection, biometric recognition, user registration and device detection and identification.

20. The network of devices of claim 13 wherein the customized remote user interface is generated by a preference engine.

21. The network of devices of claim 20 wherein user behaviors are learned by the preference engine and stored in a database.

22. The network of devices of claim 13 wherein the customized remote user interface includes a remote user interface with features added or deleted.

23. The network of devices of claim 13 wherein the user preferences are stored in a database.

24. The network of devices of claim 23 wherein the database includes groups of users with preferences separated by the groups.

25. The network of devices of claim 23 wherein the database is stored on a storing device selected from the group consisting of a hard disk drive, a solid-state drive and a memory card.

26. The network of devices of claim 13 wherein the detection device, the server device and the rendering device are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray writer/player, an ebook reader, near field devices, monitoring devices, robots, a television, a home entertainment system and an intelligent appliance.

27. A system programmed in a controller in a device comprising:
a. a discovery module for discovering devices on a network;
b. a detection module for detecting a user's presence;
c. a user preference engine for learning the user's preferences, communicating with a database and generating a customized remote user interface utilizing the user's preferences; and
d. a communication module for communicating the customized remote user interface to a rendering device.

28. The system of claim 27 wherein detecting the user's presence is selected from the group consisting of face detection, voice detection, biometric recognition, user registration and device detection and identification.

29. The system of claim 27 wherein the customized remote user interface includes a remote user interface with features added or deleted.

30. The system of claim 27 wherein the user preferences are stored in a database.

31. The system of claim 30 wherein the database includes groups of users with preferences separated by the groups.

32. The system of claim 30 wherein the database is stored on a storing device selected from the group consisting of a hard disk drive, a solid-state drive and a memory card.

33. The system of claim 27 wherein the controller is selected from the group consisting of a programmed computer readable medium and an application-specific circuit.

34. A server device comprising:
a. a memory for storing an application, the application for:
i. generating a customized remote user interface based on user preferences; and
ii. sending the customized remote user interface to a rendering device;
iii. allowing user settings and corrections to the customized remote user interface; and
b. a processing component coupled to the memory, the processing component for processing the application.

35. The server device of claim 34 wherein generating the customized remote user interface is by a user preferences engine which utilizes the user preferences.

36. The server device of claim 34 wherein the customized remote user interface includes a remote user interface with features added or deleted.

37. The server device of claim 34 wherein the user preferences are stored in a database.

38. The server device of claim 37 wherein the database includes groups of users with preferences separated by the groups.

39. The server device of claim 37 wherein the database is stored on a storing device selected from the group consisting of a hard disk drive, a solid-state drive and a memory card.
